(19) United States
(12) Patent Application Publication
(10) Pub. No.: US 2022/0080794 A1
(43) Pub. Date: Mar. 17, 2022

(54) Articulating Trailer

(71) Applicant: Mark Gaige, Cambridge, ID (US)

(72) Inventor: Mark Gaige, Cambridge, ID (US)

(21) Appl. No.: 17/240,992

(22) Filed: Apr. 26, 2021

Related U.S. Application Data
(60) Provisional application No. 62/981,882, filed on Feb. 26, 2020.

(51) Int. Cl. B60D 1/48; B60D 1/07

(52) U.S. Cl. CPC B60D 1/48; B60D 2001/544; B60D 1/075

(57) ABSTRACT

The invention described herein relates to an articulating trailer. The articulating trailer is configured such that it can be used with an automobile and/or an all-terrain vehicle. The articulating trailer may have two or more removable free wheels or skids mounted to it. The wheels (or skids) may be mounted substantially on the sides of the trailer. Alternatively, the wheels (or skids) may be mounted substantially underneath the trailer bed. The articulating trailer is configured with a trailer tongue extension. The trailer tongue extension is configured such that it attaches to the trailer at one or more independent attachment points. A user may release one attachment point of the trailer tongue extension causing the trailer to articulate.

### PRIORITY/CROSS-REFERENCE TO RELATED APPLICATIONS

This application claims the benefit of U.S. Provisional Application No. 62/981,882 filed on Feb. 26, 2020, the disclosure of which is incorporated by reference.

### TECHNICAL FIELD

The presently disclosed technology relates to vehicle trailers. More particularly, the present invention is an articulating trailer that is adapted for use, for example on an automobile as a hitch platform or alternatively on an all-terrain vehicle as a trailer.

### BACKGROUND

Vehicle trailers are commonly used for various reasons. Trailers can be used on a variety of vehicles, including both automobiles and on all-terrain vehicles. A trailer for an automobile can come in a variety of different shapes and sizes. The trailer for the automobile may be used to move both large and small items. These types of trailers may be in the form of an open trailer or a closed trailer.

Automobiles also commonly use basket trailer configurations. The basket trailer is such that it attaches to the automobile in much of the same way as a normal trailer but is typically significantly smaller in size. Basket trailers also do not commonly have wheels since they do not typically come into contact with the ground. Instead, they remain suspended off the ground when they are attached to the automobile.

All-terrain vehicles may also commonly be found with trailers. The all-terrain vehicle trailer is typically smaller than a normal automobile trailer. Further, the all-terrain vehicle trailer may require a hitch that differs from the standard hitch found in an automobile, such as a ball hitch.

Some trailers may also have the ability to articulate. The articulation of a trailer would more easily allow a user to remove the load they are hauling from the trailer bed. This feature can be advantageous in all-terrain vehicle trailers where a user may be on their own hauling a heavy load that would not be as easy to unload alone.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

The invention described herein is directed to an articulating trailer that is adapted for use as a hitch mounted platform or basket on an automobile and/or on an all-terrain vehicle. The articulating trailer may also be used as a trailer on an automobile and/or on an all-terrain vehicle. The articulating trailer has a trailer bed, a male trailer coupler, a removable trailer tongue extension and at least two axle receivers. The male trailer coupler has at least one through hole configured to mount the articulating trailer to an automobile and/or all-terrain vehicle.

The trailer tongue extension has two ends. The trailer tongue extension is configured to mount to the male trailer coupler at a first end. At the opposite end of the trailer tongue extension, it is configured to mount the articulating trailer to an automobile and/or all-terrain vehicle. In one embodiment, the trailer tongue extension has at least two pairs of through holes. The first pair of through holes is located at the first end of the trailer tongue extension and the second pair of through holes is located at the opposite end. The first pair of through holes at the first end is configured to mount the trailer tongue extension to the male trailer coupler via the through hole located thereon. The second pair of through holes of the trailer tongue extension is configured to mount the articulating trailer to an automobile and/or all-terrain vehicle.

In another embodiment, the male trailer coupler has at least one downward facing bracket. The downward bracket has a pair of opposing through holes. The downward bracket is located at an intermediate position under the trailer bed. In this embodiment, the trailer tongue extension has at least one upward facing bracket. The upward bracket of the trailer tongue extension is positioned at an intermediate positon proximate to the first end. The upward bracket of the trailer tongue extension has a pair of opposing through holes corresponding to the through hole of the male trailer coupler configured to attach the trailer tongue extension thereto. The downward bracket of the male trailer coupler and the upward bracket of the trailer tongue extension are configured such that the trailer tongue extension may be mounted to the articulating trailer at two attachment points. A user may remove the pin from the upward bracket, causing the trailer bed to articulate.

The trailer bed is configured to mount wheels. The wheels are preferably free wheels. The wheels can be mounted substantially on opposite sides of the trailer bed.

In an alternative embodiment, the wheels may be mounted to the trailer bed as part of opposing triangular support frames positioned underneath the trailer bed. The triangular support frames are positioned substantially opposite from one another such that the wheels are on opposite sides under the trailer bed. The triangular support frames can be removable from the trailer bed. The wheels are removable from the triangular support frame.

In another alternative embodiment, the wheels are mounted to the trailer bed as part of opposing triangular support frames that are integral with the trailer bed and positioned substantially underneath the trailer bed. The wheels are mounted substantially underneath the trailer bed on opposing sides at each triangular support frame. The wheels are removable from the integral triangular support frame. The integral triangular support frames are connected to one another via an integral axle extending between the opposing triangular support frames. The axle is located a distance underneath the trailer bed. The axle may have a pair of opposing upward brackets positioned substantially in the middle thereof. The upward brackets are configured to mount the trailer tongue extension thereto via a through hole.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 illustrates a perspective view of one embodiment of an articulating trailer with a trailer tongue extension attached

FIG. 2 illustrates a perspective view of one embodiment of an articulating trailer with a trailer tongue extension in an articulated position.

FIG. 3 illustrates an enlarged view of the embodiment of FIG. 2.

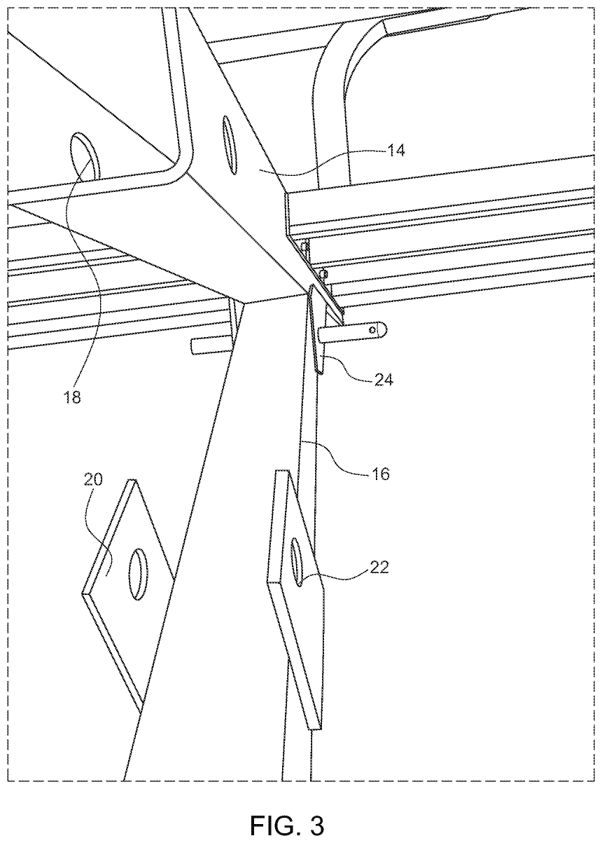

FIG. 4 illustrates a perspective view of one embodiment of an articulating trailer wheel connection.

FIG. 5 illustrates another perspective view of the wheel connection embodied in FIG. 4.

FIG. 6 illustrates a perspective view of the embodiment of FIG. 4 depicting a wheel disconnected from an articulating trailer.

FIG. 7 illustrates an enlarged view of an articulating trailer mounted to a automobile.

FIG. 8 illustrates another embodiment of an articulating trailer mounted to a automobile.

FIG. 9 illustrates a perspective view of the embodiment of FIG. 8 with a wheel disconnected from an articulating trailer.

FIG. 10 illustrates a perspective view of another embodiment of an articulating trailer.

FIG. 11 illustrates a perspective view of multiple trailer tongue extensions connected together and connected to an all-terrain automobile.

### DESCRIPTION

While the presently disclosed technology is susceptible of various modifications and alternative constructions, certain illustrated embodiments thereof have been shown in the drawings and will be described below in detail. It should be understood, however, that there is no intention to limit the claimed technology to the specific form disclosed, but, on the contrary, the presently disclosed and claimed technology is to cover all modifications, alternative constructions, and equivalents falling within the spirit and scope of the inventive concept(s) as defined in the claims.

In accordance with the present invention is a new and improved articulating trailer. The articulating trailer is configured to be adaptable for use between different vehicles. The articulating trailer can be used interchangeably, for example, between automobiles and all-terrain vehicles. In use on an automobile, the articulating trailer 1 can be configured as a platform or a basket. In use on an all-terrain vehicle, the articulating trailer 1 can be configured as a trailer. The articulating trailer may be used on road and off road.

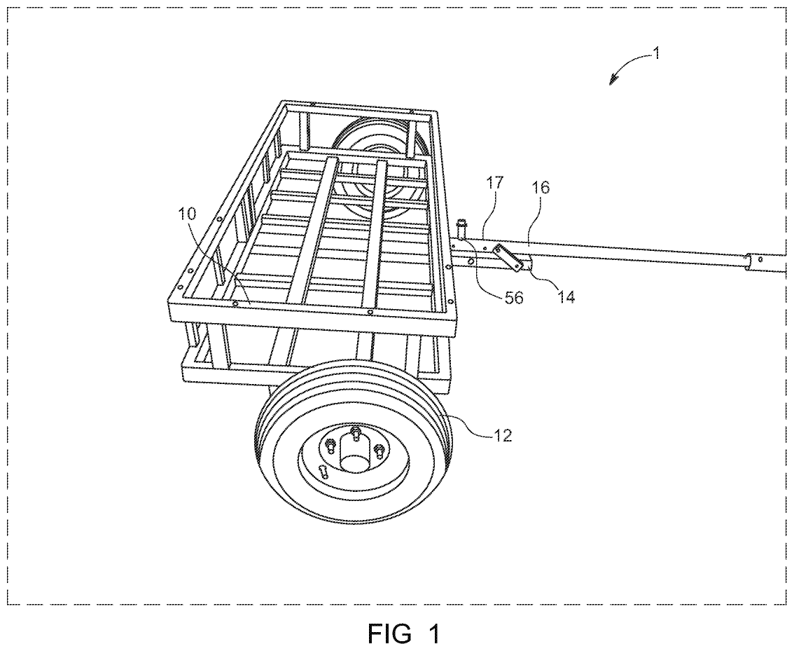

FIG. 1 illustrates a perspective view of a first embodiment of an articulating trailer. The articulating trailer 1 has a trailer bed 10 and at least two wheels 12. Wheels are understood to include skids and/or skis that may be mounted in the same fashion. In the embodiment of FIG. 1, the wheels 12 are positioned substantially on opposing sides of the trailer bed 10. The wheels 12 are configured to be removably attached to the trailer bed 10.

The articulating trailer 1 has a male trailer coupler 14. The male trailer coupler 14 is configured to attach the articulating trailer 1 to a female trailer receiver of an automobile or all-terrain vehicle. The male trailer coupler 14 may be the standard 2″×2″ male trailer coupler. Alternatively, the male trailer coupler 14 may be larger or smaller than the standard size. The male trailer coupler 14 has at least one through hole 18. The through hole 18 is configured to receive a locking pin such that the articulating trailer can be mounted to an automobile or all-terrain vehicle. Alternatively, other suitable locking mechanisms, such as a nut and bolt, may be used to mount the articulating trailer via the through hole. The through hole 18 is also configured to receive a locking pin to mount a trailer tongue extension 16. The trailer tongue extension has a first end 17 and a second end 19. The trailer tongue extension 16 is configured to extend the length of the male trailer coupler 14. The trailer tongue extension 16 can be of varying lengths. The tongue extension is preferably between five (5) feet to eight (8) feet. The trailer tongue extension 16 may have a top through hole 56 configured for the insertion of a locking pin. The top through hole 56 of the trailer tongue extension corresponds to a top through hole 54 on the male trailer coupler 14.

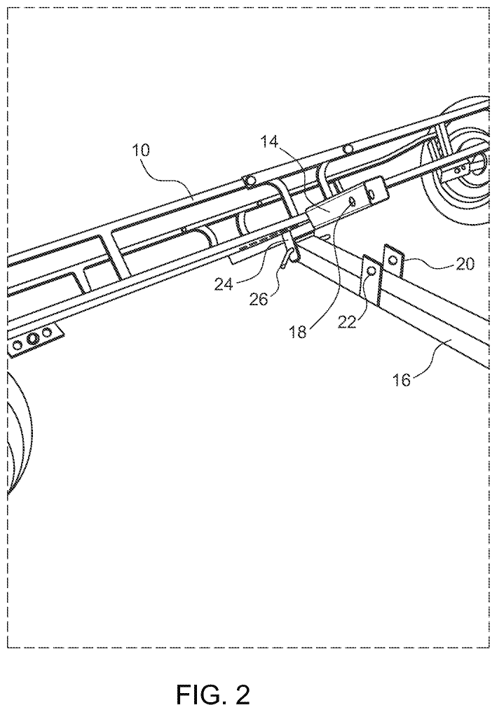

FIG. 2 illustrates the trailer tongue extension 16 in an articulated position. The trailer tongue extension 16 has at least one upward bracket 20. The upward bracket 20 has a pair of opposing through holes 22. The upward bracket 20 of the trailer tongue extension 16 is configured to mount the trailer tongue extension 16 through the through holes 18 of the male trailer coupler 14. The trailer bed 10 may have at least one downward bracket 24. The downward bracket 24 is positioned on the underneath side of the trailer bed 10. The downward bracket 24 is positioned so as to be in a straight line with the male trailer coupler 14. The downward bracket 24 has a pair of opposing through holes 26 configured to receive a locking pin.

FIG. 2 illustrates the articulating trailer 1 in an articulated position. The trailer tongue extension 16 is configured such that there may be two attachment points. A first attachment point is positioned at the first end 17 of the trailer tongue extension 16. The trailer tongue extension 16 is configured such a through hole positioned at the first end 17 aligns with the through holes 26 of the downward bracket 24 of the trailer bed 10. A second attachment point is positioned at the upward bracket 20 of the trailer tongue extension. The upward bracket 20 is configured to attach to the male trailer coupler 14 at the through holes 18 via a locking pin. The positioning of the downward bracket 24 on the trailer bed and the upward bracket 20 on the trailer tongue extension are such that the trailer tongue extension 16 may be attached at both points simultaneously.

The trailer tongue extension is configured such that a user can remove the locking pin at the second attachment point causing the trailer to articulate. In the articulated position, the tongue extension remains attached to the downward bracket of the trailer bed at the first attachment point. This position allows a user to easily unload gear from the trailer bed.

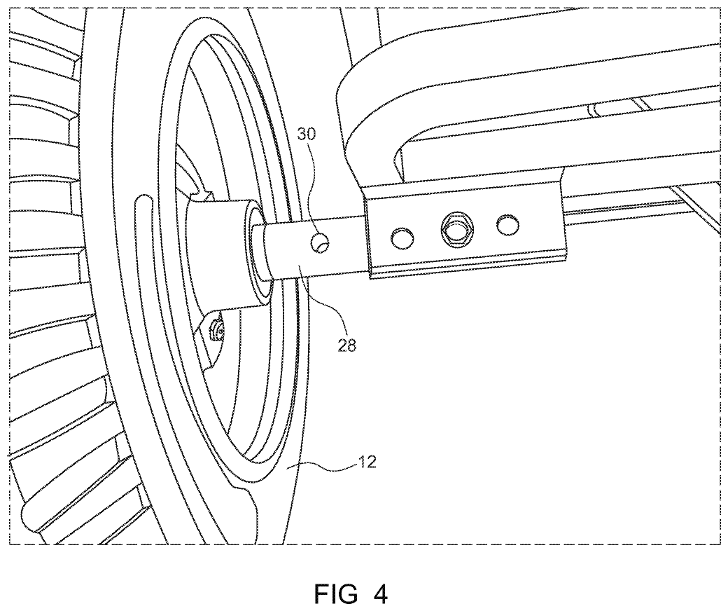

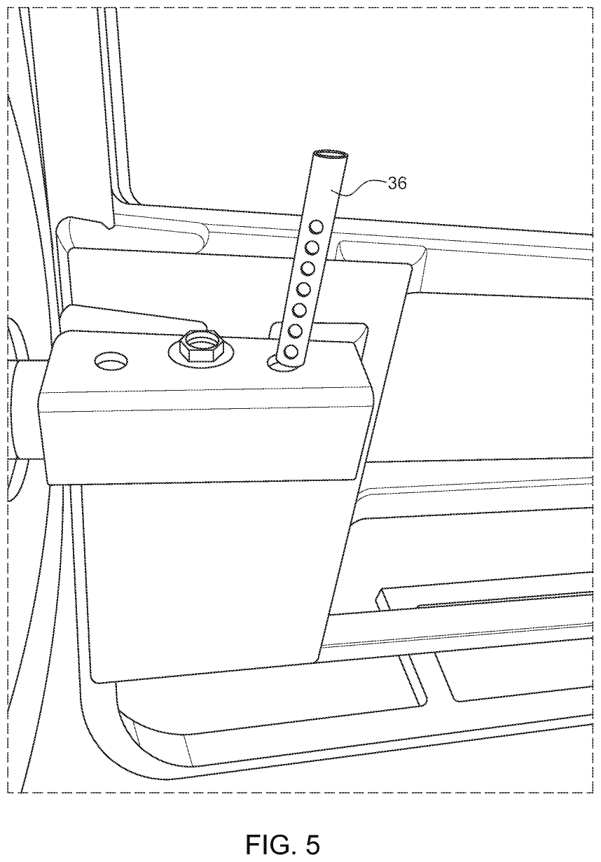

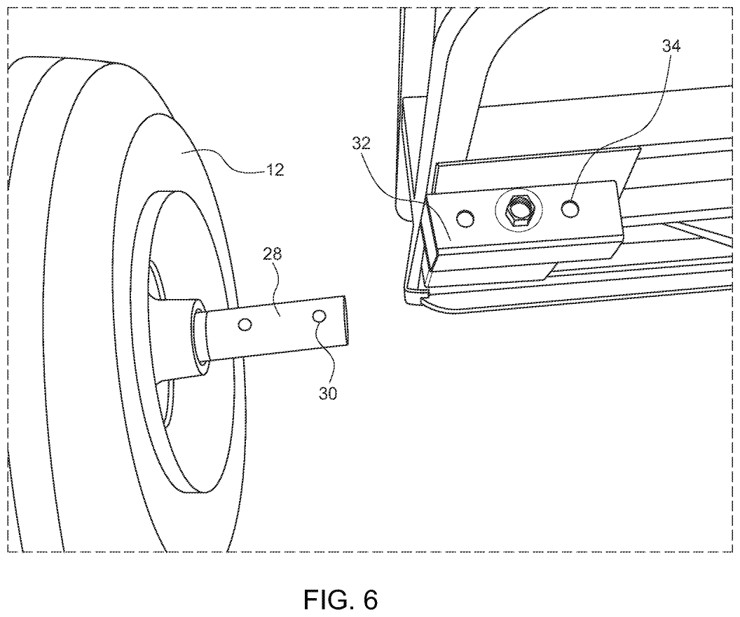

FIG. 4 through 6 illustrates differing views of one embodiment of a wheel 12 mounted to the trailer bed 10. The wheel 12 is preferably a free wheel. The wheel 12 has a wheel axle 28. The wheel axle 28 has at least one through hole 30. In the embodiments depicted in FIGS. 4 through 6, trailer bed 10 has a pair of axle receivers 32 positioned on opposite sides thereof configured to mount the wheel 12 to the trailer bed 10. The axle receivers 32 are configured to receive the wheel axle 28. The axle receivers 32 have at least on through hole 34. The wheel 12 is configured to be mounted to the trailer bed 10 by inserting the wheel axle 28 into the axle receiver 32 and locking the wheel 12 in place via a locking pin 36 inserted through through holes 30, 34. FIG. 5 illustrates an enlarged view of the locking pin 36 in an almost engaged position with the through holes 30, 34. FIG. 6 illustrates the wheel 12 in a disconnected position.

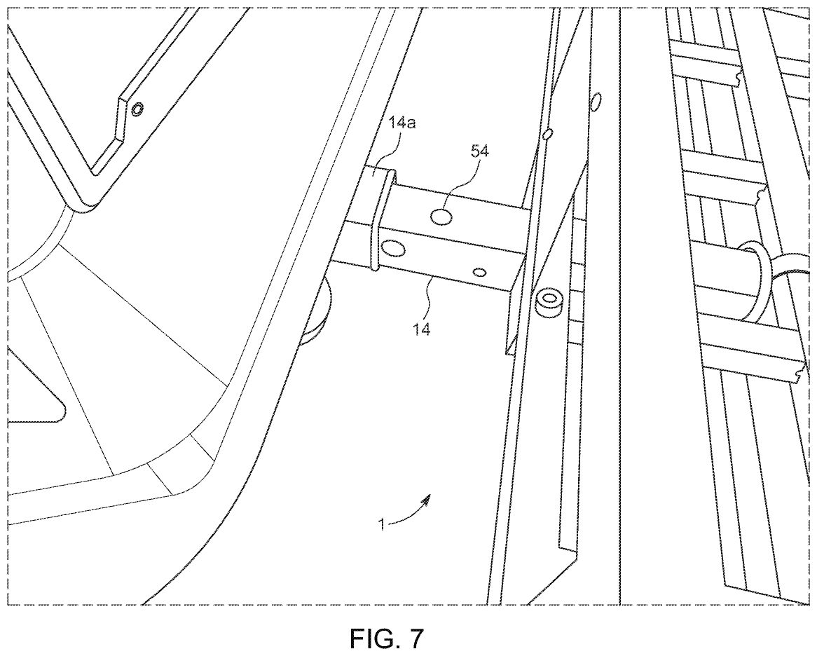

FIG. 7 illustrates one embodiment of the articulating trailer 1 as it is mounted to an automobile. The male trailer coupler 14 is configured to insert into a female receiver 14a on the automobile. FIG. 7 clearly illustrates the top through hole 54 of the male trailer coupler 14. When mounted to an automobile, the articulating trailer may be used as a basket/platform such that the wheels of the articulating trailer do not touch the ground.

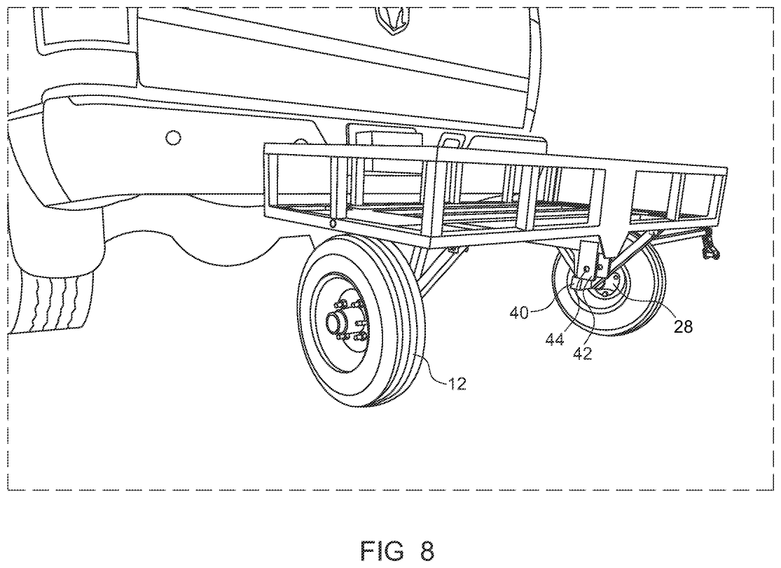

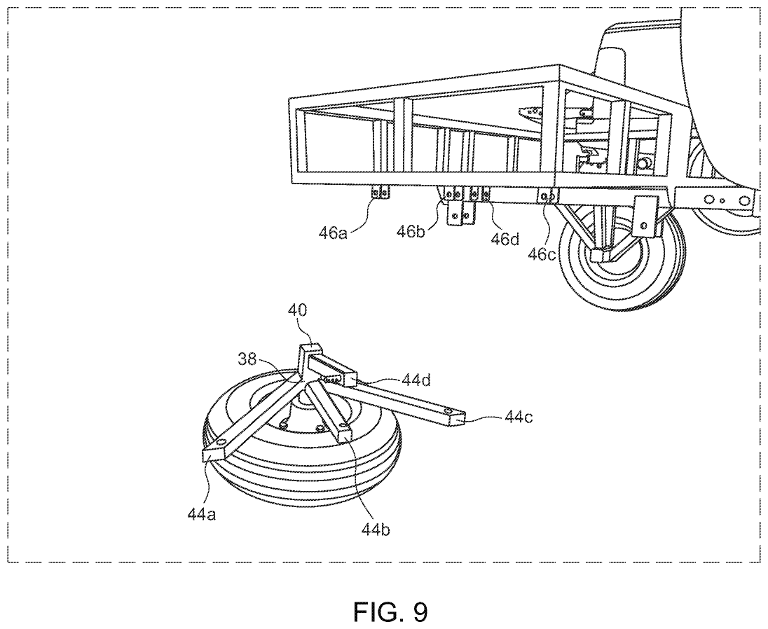

FIGS. 8 and 9 illustrate another embodiment of the articulating trailer. In this embodiment, the wheel 12 is mounted substantially underneath the trailer bed 10. The wheel 12 is mounted using a triangular support frame 38. The wheel axle 28 is configured to attach to an axle receiver 40 positioned on the lower end of the triangular support frame 38. In this embodiment, there is at least one downward bracket 42 positioned substantially at the rear of the trailer bed 10. The downward bracket 42 has a pair of through holes 44. The trailer tongue extension 16 (not depicted in FIGS. 8 and 9) is configured to mount to the downward bracket 42 via the through holes and locking pin.

The triangular support frame 38 is configured to be removable from the trailer bed 10. The triangular support frame 38 has four support arms 44a, 44b, 44c, 44d. The support arms 44a, 44b, 44c, 44d are configured to mount to corresponding brackets 46a, 46b, 46c, 46d positioned on the underneath side of the trailer bed 10. Mounting is accomplished through the use of a locking pin configured to be inserted through the corresponding through holes.

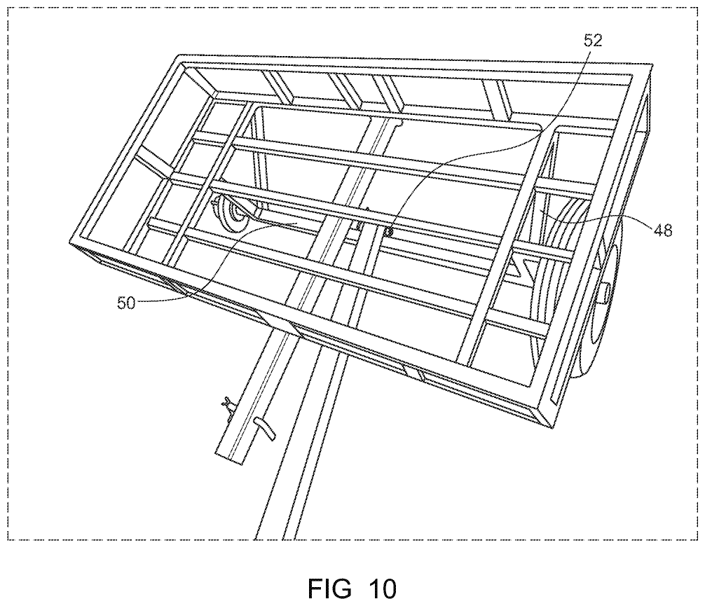

FIG. 10 illustrates another embodiment of the articulating trailer 1. In the embodiment depicted, the triangular support frame 48 is integral to the trailer bed 10. The triangular support frame 48 is mounted substantially underneath on opposing sides of the trailer bed 10. The opposing triangular support frames 48 are connected to one another via an axle 50. The axle 50 is located a distance beneath the trailer bed 10. Positioned substantially in the middle of the axle 50 is an upward bracket 52. The upward bracket 52 is configured to attach the trailer tongue extension 16 via a pair of through holes and locking pin.

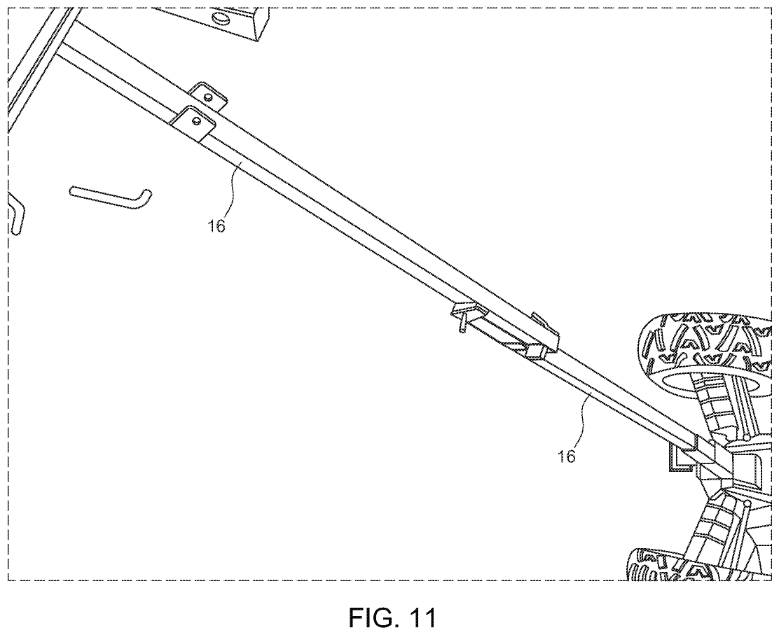

FIG. 11 illustrates a perspective view of the trailer tongue extension 16. The trailer tongue extension 16 is configured such that multiple trailer tongue extensions may be attached together thereby increasing the overall length of the extension.

The articulating trailer described herein may also be fitted with a standard hitch for mounting to a standard ball hitch on an automobile and/or all-terrain vehicle. Further, the articulating trailer may be rotated and pulled from a substantially horizontal direction. This would ensure the trailer fits through a narrow trail entrance when being used on an all-terrain vehicle. The trailer bed can be configured to haul various cargo, such as hunting game, camping gear, firewood, water barrels, gas cans, other types of freight, or any other type of cargo that a user desires to haul. Alternatively the trailer bed can be configured to haul a boat.

The trailer tongue extension may be configured such that it is telescoping. This configuration allows a user to easily adjust the overall length of the tongue extension.

The tongue extension may have a bow rest attached thereto. The bow rest is configured to support the front end of a boat. In an alternate embodiment, the front end of the boat is configured to attach to a pivoting mount or bow rest attached to the rear of an automobile or all-terrain vehicle.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

I claim:

1. An articulating trailer, said articulating trailer comprising:
a trailer bed, wherein said trailer bed has a male trailer coupler configured for the attachment to a female receiver, said male trailer coupler having a first end and a second end, wherein said first end extends beyond said trailer bed and is configured for mating engagement with a female receiver, and wherein said second end of said male trailer coupler extends a distance under said trailer bed;
said male trailer coupler having at least one through hole positioned at said first end, wherein said through hole is configured to receive a locking pin;
a removable trailer tongue extension, said trailer tongue extension having a first end and a second end, wherein said first end has a first through hole and said second end has a second through hole, said through holes being configured to receive a locking pin, wherein said first through hole of said first end of said trailer tongue extension is configured to attach to said male trailer coupler, said second through hole of said second end of said trailer tongue extension is configured to attach to a vehicle; and
wherein said trailer bed is configured for the attachment of at least two wheels.

2. The articulating trailer of claim 1, wherein said first through hole of said trailer tongue extension is configured to attach said trailer tongue extension to said male trailer coupler at said through hole of said first end of said male trailer coupler.

3. The articulating trailer of claim 1, wherein said male trailer coupler further comprises at least one downward bracket positioned thereon intermediate to said first end and said second end of said male trailer coupler.

4. The articulating trailer of claim 3, wherein said downward bracket of said male trailer coupler has a pair of through holes, said through holes configured to receive a locking pin and wherein said downward bracket is configured to attach said trailer tongue extension at said first through hole of said trailer tongue extension.

5. The articulating trailer of claim 4, wherein said trailer tongue extension has at least one upward bracket, said upward bracket having a pair of opposing through holes and being positioned on said trailer tongue extension such that said upward extending sidewalls match said through holes of said male trailer coupler.

6. The articulating trailer of claim 1, wherein said wheels are positioned on opposing sides of said trailer bed.

7. The articulating trailer of claim 1 further comprising an axle positioned under said trailer bed and extending the length of said trailer bed wherein said wheels are positioned at opposing ends of said axle.

8. The articulating trailer of claim 7, wherein said axle is configured to attach a removable downward triangular support frame, said support frame being configured to attach said wheels wherein said wheels are positioned under said trailer bed.

9. The articulating trailer of claim 7, wherein said axle has a pair of opposing integral downward triangular support frames wherein said wheels are mounted on said support frames such that said wheels are positioned under said trailer bed.

10. The articulating trailer of claim 1, further comprising a pair of opposing integral downward extending triangular support frames wherein said wheels are mounted on each of said integral support frames, said support frames being connected by an axle, said axle being positioned a distance under said trailer bed.

11. The articulating trailer of claim 10, wherein said axle has an upward bracket, said upward bracket positioned substantially in the middle of said axle, said upward bracket having a pair of opposing through holes wherein said through holes are configured to receive a locking pin.

12. The articulating trailer of claim 10, wherein said trailer tongue extension further comprises an upward bracket, wherein said upward bracket has a pair of opposing through holes, said through holes being configured to receive a locking pin, and wherein said first through hole of said first end of said trailer tongue extension is positioned such that it corresponds to said upward bracket of said axle and wherein said upward bracket of said trailer tongue extension is positioned such that it matches said through hole of said male trailer coupler such that said trailer tongue extension is configured to have two independent connection points with said trailer bed.
